(19) United States
(12) Patent Application Publication
(10) Pub. No.: US 2011/0199011 A1
(43) Pub. Date: Aug. 18, 2011

(54) LIGHT-EMITTING DIODE DRIVING CIRCUIT AND PLANAR ILLUMINATING DEVICE HAVING SAME

(76) Inventor: Ken Nakazawa, Osaka-shi Osaka (JP)

(21) Appl. No.: 12/998,483

(22) PCT Filed: Aug. 28, 2009
(86) PCT No.: PCT/JP2009/065091

§ 371 Date: Apr. 26, 2011

(30) Foreign Application Priority Data
Jan. 9, 2009 (JP) 2009-003497

(51) Int. Cl. H05B 37/02

(52) U.S. Cl. 315/193

(57) ABSTRACT

There is provided an LED driver capable of preventing deterioration of display quality for moving image display in a display device employing, as a backlight, light-emitting diodes formed in a plurality of rows. An LED driver includes a plurality of bypass switches connected in parallel with a respective plurality of light-emitting diodes; switch control circuits that control on and off states of the bypass switches; registers provided in one-to-one correspondence with the bypass switches; a first counter and a second counter that count clocks; and comparators that compare the value of the first counter or the second counter with the values of the registers. Here, as timing control signals, a first reset signal is provided to the first counter and a second reset signal is provided to the second counter.

### TECHNICAL FIELD

The present invention relates to a planar illuminating device, and more particularly to a light-emitting diode driving circuit that drives a plurality of light-emitting diodes used as light sources in a planar illuminating device which irradiates light from the back side of a display device.

### BACKGROUND ART

In image display devices having a backlight such as liquid crystal display devices, by controlling the luminance of the backlight based on an input image, the power consumption of the backlight can be suppressed and the image quality of a displayed image can be improved. In particular, by dividing a screen into a plurality of areas and controlling, based on input images in the respective areas, the luminances of backlight light sources associated with the respective areas, a further reduction in power consumption and a further improvement in image quality can be achieved. A method of driving a display panel while thus controlling the luminances of backlight light sources based on input images in the respective areas is hereinafter referred to as the “area active drive”.

A display device employing the above-described area active drive typically employs light-emitting diodes (LEDs) as backlight light sources. In a backlight device, a plurality of sets of light-emitting diodes, each including a plurality of light-emitting diodes connected in series (e.g., one set of light-emitting diodes includes four light-emitting diodes), are arranged and a constant current is provided to each set of light-emitting diodes. Regarding such a backlight device, Japanese Patent Application Laid-Open No. 2005-310996 discloses an invention in which transistors serving as switches are provided in parallel with respective light-emitting diodes and by switching on and off of the transistors by PWM signals, the luminances of the individual light-emitting diodes are adjusted.

FIG. 18 is a schematic diagram showing an exemplary configuration of a main part of a conventional LED driver 900. Note that FIG. 18 shows a configuration for driving a set of light-emitting diodes, including four light-emitting diodes LED1 to LED4. As shown in FIG. 18, the LED driver 900 includes switches SW1 to SW4 provided in parallel with the respective four light-emitting diodes LED1 to LED4 composing the set of light-emitting diodes; a PWM control circuit 901 that controls the on and off states of the switches SW1 to SW4 by PWM signals P1 to P4; a shift register 902 for setting values according to the target light-emission luminances of the respective light-emitting diodes LED1 to LED4 (hereinafter, referred to as the “target luminances”), in predetermined registers (registers REG1 to REG4 which will be described later); and a constant-current drive circuit 903 for providing a constant current to the set of light-emitting diodes by allowing an FET (Field-Effect Transistor) or the like to function as a constant-current source 911. Note that, since the current flow through the light-emitting diodes is controlled by switching the switches SW1 to SW4 on and off which are provided in parallel with the respective light-emitting diodes LED1 to LED4, these switches are hereinafter referred to as the “bypass switches”.

FIG. 19 is a block diagram showing configurations of the PWM control circuit 901 and its peripheral portion in the conventional LED driver 900. The PWM control circuit 901 includes switch control circuits SC1 to SC4 that control the on and off states of the bypass switches SW1 to SW4 by PWM signals P1 to P4; registers REG1 to REG4 provided in one-to-one correspondence with the bypass switches SW1 to SW4; a counter 905 that counts pulses of a PWM control circuit clock signal PCLK; and comparators CMP1 to CMP4 that compare the value of the counter with the values of the registers REG1 to REG4.

In the configurations shown in FIGS. 18 and 19, in the registers REG1 to REG4, values according to the target luminances of their corresponding light-emitting diodes LED1 to LED4 are stored. The value of the counter 905 is reset (set to zero) by a pulse of a reset signal RST and is incremented by one according to a pulse of the PWM control circuit clock signal PCLK. Each of the bypass switches SW1 to SW4 is placed in an off state when the value of the counter 905 is reset, and is placed in an on state when the value of the counter 905 matches the values of their corresponding registers REG1 to REG4. Note that FIG. 19 shows an example in which the counter 905 and the registers REG1 to REG4 are 12 bits. In this case, the configuration is such that “(because 2 raised to the 12th power is 4096) every time the 4096th pulse of the PWM control circuit clock signal PCLK is generated, a pulse of the reset signal RST is generated”. In the above-described manner, the LED driver 900 performs PWM control for setting the luminances of the respective light-emitting diodes LED1 to LED4 to their respective target luminances, with 4096 clocks of the PWM control circuit clock signal PCLK provided from an external source being one cycle. By this, each of the light-emitting diodes LED1 to LED4 is placed in a turn-on state only for a desired period (a period according to a target luminance) during one cycle (of PWM control).

Meanwhile, a display unit of a display device employing area active drive is divided into a plurality of areas. As shown in FIG. 3, a plurality of light-emitting diodes L1, L2, L3, . . . are provided on the back side of the display unit such that one light-emitting diode is associated with one area. Then, as shown in FIG. 20, one LED driver is provided per a plurality of light-emitting diodes (four light-emitting diodes in the example shown in FIG. 20). In such a configuration, the timing of generation of a pulse of a reset signal RSTb provided to LED drivers LD3 and LD4 is delayed relative to the timing of generation of a pulse of a reset signal RSTa provided to LED drivers LD1 and LD2. Hence, light-emitting diodes L9 to L16 are turned on at a timing delayed relative to the timing of turning on of light-emitting diodes L1 to L8. In this manner, the plurality of light-emitting diodes shown in FIG. 3 are turned on in the order shown in FIG. 8. Specifically, the plurality of light-emitting diodes provided on the back side of the display unit are sequentially turned on row by row.

However, if each set of light-emitting diodes is arranged as shown in FIG. 20, i.e., if a plurality of light-emitting diodes included in each set of light-emitting diodes are arranged in one row on the back side of the display unit, then the distance between a light-emitting diode and an LED driver, e.g., between the light-emitting diode L1 and the LED driver LD1, is long, increasing a voltage drop caused by wiring resistance between the two. This LED driver is configured such that by allowing a current to flow through the above-described bypass switch, a corresponding light-emitting diode is turned off. However, when the above-described voltage drop increases, the current also flows through the light-emitting diode and accordingly the light-emitting diode is turned on. Due to this, when the above-described voltage drop increases, a light-emitting diode that is supposed to be in a turn-off state is turned on. To prevent the above-described voltage drop from thus becoming greater than or equal to a predetermined level, constraints are imposed on area size and wiring width.

In view of this, there is proposed a technique in which by arranging each set of light-emitting diodes as shown in FIG. 21, i.e., by arranging each set of light-emitting diodes such that a plurality of light-emitting diodes included in the set of light-emitting diodes are arranged in two rows on the back side of the display unit, the distance between the light-emitting diodes and a corresponding LED driver is shortened. According to the configuration shown in FIG. 21, all light-emitting diodes do not have a long distance to their corresponding LED drivers, thereby suppressing the occurrence of abnormality in turning (meaning that a light-emitting diode that is supposed to be in a turn-off state is turned on) on which results from a voltage drop between a light-emitting diode and an LED driver. In addition, in the configuration shown in FIG. 18, in the case in which the constant-current drive circuit 903 is configured to stop the current of the constant-current source 911 when all of the bypass switches SW1 to SW4 are placed in an on state (when all of the light-emitting diodes LED1 to LED4 are placed in a turn-off state), the effect of a reduction in power consumption is more likely to be obtained with a shorter distance between light-emitting diodes. From this point of view, too, a great advantage is obtained with the configuration shown in FIG. 21 over the configuration shown in FIG. 20.

Note that, in connection with the invention of the present application, conventional art such as those shown below is known. Japanese Patent Application Laid-Open No. 2005-310999 discloses, as described above, the invention in which by switching the on and off states of switches provided in parallel with the respective light-emitting diodes, the luminances of the individual light-emitting diodes are adjusted. In addition, Japanese Patent Application Laid-Open No. 2001-125066 and Japanese Patent No. 3229250 disclose inventions of liquid crystal display devices with which high-quality moving image display is obtained.

### PRIOR ART DOCUMENTS

### Patent Documents

[Patent Document 1] Japanese Patent Application Laid-Open No. 2005-310999

[Patent Document 2] Japanese Patent Application Laid-Open No. 2001-125066

[Patent Document 3] Japanese Patent No. 3229250

### SUMMARY OF THE INVENTION

### Problems to be Solved by the Invention

However, in the case in which the LED driver 900 of the configuration shown in FIGS. 18 and 19 is employed when each set of light-emitting diodes is arranged as shown in FIG. 21, LED drivers LD1 to LD4 turn on light-emitting diodes L1 to L8 in the first row and light-emitting diodes L9 to L16 in the second row at the same timing. Accordingly, the plurality of light-emitting diodes shown in FIG. 3 are turned on in the order shown in FIG. 22. Specifically, the plurality of light-emitting diodes provided on the back side of the display unit are sequentially turned on two rows by two rows. When turning on is performed in such an order, as described in the above-described Japanese Patent No. 3229250, display quality for moving image display deteriorates.

An object of the present invention is therefore to provide an LED driver (light-emitting diode driving circuit) capable of preventing deterioration of display quality for moving image display in a display device that employs, as a backlight, light-emitting diodes formed in a plurality of rows.

### Means for Solving the Problems

A first aspect of the present invention is directed to a light-emitting diode driving circuit that drives a plurality of light-emitting diodes which are connected in series with each other and which are connected in series with a constant-current source for allowing a constant current to flow, the light-emitting diode driving circuit comprising:

a plurality of switches, each of which is connected in parallel with each of the plurality of light-emitting diodes or is connected in parallel with a predetermined number of light-emitting diodes; and

a PWM signal generating unit that generates PWM signals for switching on and off states of the respective switches connected in parallel with their corresponding light-emitting diodes, according to target luminances of the respective light-emitting diodes, wherein

the PWM signal generating unit generates the PWM signals based on a plurality of timing control signals for controlling timings at which the plurality of switches are placed in one of an on state and an off state as an initial state.

According to a second aspect of the present invention, in the first aspect of the present invention,

the PWM signal generating unit includes:
a plurality of luminance correspondence value holding units that are provided to be associated with the respective plurality of switches and that hold luminance correspondence values, each luminance correspondence value being a value according to a target luminance of a light-emitting diode associated with a corresponding switch and being a value associated with a number of pulses of a clock signal provided from an external source;
a plurality of counters provided such that the plurality of timing control signals are provided thereto, respectively, each counter counting a number of pulses of the clock signal and outputting the number of pulses as a count value; and
a plurality of switch switching units which are provided to be associated with the respective plurality of switches, and each of which compares a luminance correspondence value held in a luminance correspondence value holding unit associated with a corresponding switch with a count value outputted from one of the plurality of counters, and switches on and off states of the switch from its initial state when the luminance correspondence value matches the count value, wherein

each switch is placed in an initial state based on a timing control signal provided to a counter that outputs a count value compared by a switch switching unit associated with the switch, and

a count value outputted from each counter is reset based on a timing control signal provided to the counter.

According to a third aspect of the present invention, in the second aspect of the present invention,

a counter that outputs a count value to be compared by each switch switching unit is determined in advance.

According to a fourth aspect of the present invention, in the second aspect of the present invention,

the PWM signal generating unit further includes a counter selecting unit that selects, based on predetermined instruction data, a counter that outputs a count value to be compared by each switch switching unit.

According to a fifth aspect of the present invention, in the second aspect of the present invention,

the plurality of counters include a first counter that receives a timing control signal from an external source; and a second counter other than the first counter,

the PWM signal generating unit further includes:
a delay control value holding unit that holds a delay control value, the delay control value being a value according to a difference between timings at which the plurality of switches are placed in an initial state and being a value associated with a number of pulses of the clock signal; and
a timing control signal generating unit that is provided to be associated with the second counter and that generates a timing control signal to be provided to the second counter, based on the delay control value held in the delay control value holding unit and a count value outputted from the first counter, and
the timing control signal generating unit generates the timing control signal such that, when the delay control value held in the delay control value holding unit matches the count value outputted from the first counter, a count value outputted from the second counter is reset.

According to a sixth aspect of the present invention, in the first aspect of the present invention,

the light-emitting diode driving circuit further comprises a constant-current drive unit that sets a current flowing through the constant-current source to zero when the plurality of switches are all placed in an on state.

A seventh aspect of the present invention is directed to a planar illuminating device comprising a light-emitting diode driving circuit according to any one of the first through the sixth aspects of the present invention.

According to an eighth aspect of the present invention, in the seventh aspect of the present invention,

a plurality of light-emitting diodes driven by each light-emitting diode driving circuit include a first light-emitting diode group and a second light-emitting diode group, the first light-emitting diode group including light-emitting diodes arranged on one side with reference to an arrangement position of the light-emitting diode driving circuit, and the second light-emitting diode group including light-emitting diodes arranged on an other side with reference to the arrangement position of the light-emitting diode driving circuit, and

a switch connected in parallel with the first light-emitting diode group and a switch connected in parallel with the second light-emitting diode group are placed in an initial state based on different timing control signals.

### Effects of the Invention

According to the first aspect of the present invention, a switch is provided for each of a plurality of light-emitting diodes connected in series or is provided in parallel with a predetermined number of light-emitting diodes, and the on and off states of the switches are switched according to the target luminances of their corresponding light-emitting diodes. Here, the switches are placed in an initial state based on a plurality of timing control signals. Namely, some switches are placed in an initial state at a given timing, while some switches are placed in an initial state at a different timing. Hence, the plurality of light-emitting diodes can be placed in a turn-on state or a turn-off state at different timings (timings, the number of which is equal to the number of timing control signals). Accordingly, for example, in a configuration in which some of light-emitting diodes driven by a light-emitting diode driving circuit are arranged on one side of the light-emitting diode driving circuit and others are arranged on the other side in order to suppress the occurrence of abnormality in turning on which results from a voltage drop between a light-emitting diode and a light-emitting diode driving circuit, the light-emitting diodes arranged on the one side and the light-emitting diodes arranged on the other side can be turned on at different timings. By this, when light-emitting diodes formed in a plurality of rows are employed as a backlight of a display device, the light-emitting diodes can be turned on row by row, preventing deterioration of display quality for moving image display.

According to the second aspect of the present invention, by configuring a PWM signal generating unit to include a plurality of registers serving as luminance correspondence value holding units that store values according to the target luminances of the respective light-emitting diodes; a plurality of counters that are reset based on timing control signals provided thereto and that count the number of pulses of a clock signal; and switch switching units that switch the on and off states of the plurality of switches, a light-emitting diode driving circuit capable of preventing deterioration of display quality for moving image display is implemented.

According to the third aspect of the present invention, a light-emitting diode driving circuit capable of preventing deterioration of display quality for moving image display is implemented without complicating the configuration of the PWM signal generating unit.

According to the fourth aspect of the present invention, a counter that outputs a count value to be compared by each switch switching unit is determined based on instruction data. Hence, by generating instruction data taking into account the arrangement position of each light-emitting diode, the light-emitting diode can be turned on at a suitable timing. By this, a light-emitting diode driving circuit is implemented that is capable of preventing deterioration of display quality for moving image display while increasing flexibility in the positional relationship between light-emitting diodes and a light-emitting diode driving circuit.

According to the fifth aspect of the present invention, a timing control signal provided to a counter other than one of a plurality of counters provided in the PWM signal generating unit is generated within the PWM signal generating unit. Hence, the number of external input signals to be provided to the light-emitting diode driving circuit is reduced.

According to the sixth aspect of the present invention, when the switches included in the light-emitting diode driving circuit are all placed in an on state, the current flow in a constant-current source is stopped. Since the distance between light-emitting diodes can be shortened, power consumption is effectively reduced.

According to the seventh aspect of the present invention, a planar illuminating device is implemented that provides the same effect as that obtained in any of the first to sixth aspects of the present invention.

According to the eighth aspect of the present invention, when one light-emitting diode driving circuit drives a predetermined number of light-emitting diodes, the distance between each light-emitting diode and the light-emitting diode driving circuit is shorter than that for a configuration in which light-emitting diodes are arranged only on one side of a light-emitting diode driving circuit. Hence, the occurrence of abnormality in turning on which results from a voltage drop between a light-emitting diode and a light-emitting diode driving circuit is suppressed.

### BRIEF DESCRIPTION OF THE DRAWINGS

FIG. 1 is a block diagram showing configurations of a PWM control circuit and its peripheral portion included in an LED driver in an LED backlight device according to a first embodiment of the present invention.

FIG. 2 is a block diagram showing an overall configuration of a liquid crystal display device including the LED backlight device according to the first embodiment.

FIG. 3 is a diagram for describing a correspondence relationship between an area and a light-emitting diode in the first embodiment.

FIG. 4 is a diagram for describing the rendering order on a display unit in the first embodiment.

FIG. 5 is a schematic configuration diagram of the LED driver in the first embodiment.

FIG. 6 is a diagram showing an exemplary configuration to switch a bypass switch to off in the first embodiment.

FIG. 7 is a diagram for describing an effect brought about in the first embodiment.

FIG. 8 is a diagram showing the turning on order of light-emitting diodes in the first embodiment.

FIG. 9 is a block diagram showing configurations of a PWM control circuit and its peripheral portion included in an LED driver in an LED backlight device according to a second embodiment of the present invention.

FIG. 10 is a block diagram showing a detailed configuration of a counter selection circuit in the second embodiment.

FIG. 11 is a diagram for describing determination of the values of selection instruction data by a counter instructing unit in the second embodiment.

FIG. 12 is a diagram for describing count values provided to comparators in the second embodiment.

FIG. 13 is a diagram for describing an effect brought about in the second embodiment.

FIG. 14 is a diagram for describing an effect brought about in the second embodiment.

FIG. 15 is a diagram for describing an effect brought about in the second embodiment.

FIG. 16 is a block diagram showing configurations of a PWM control circuit and its peripheral portion included in an LED driver in an LED backlight device according to a third embodiment of the present invention.

FIG. 17 is a diagram for describing an effect brought about in the third embodiment.

FIG. 18 is a schematic configuration diagram of an LED driver in a conventional example.

FIG. 19 is a block diagram showing configurations of a PWM control circuit and its peripheral portion included in the LED driver according to the conventional example.

FIG. 20 is a diagram for describing a conventional example.

FIG. 21 is a diagram for describing a conventional example.

FIG. 22 is a diagram showing the turning on order of light-emitting diodes in the conventional example.

### MODE FOR CARRYING OUT THE INVENTION

Embodiments of the present invention will be described below with reference to the accompanying drawings.

### 1. First Embodiment

### 1.1 Overall Configuration and Overview of Operation

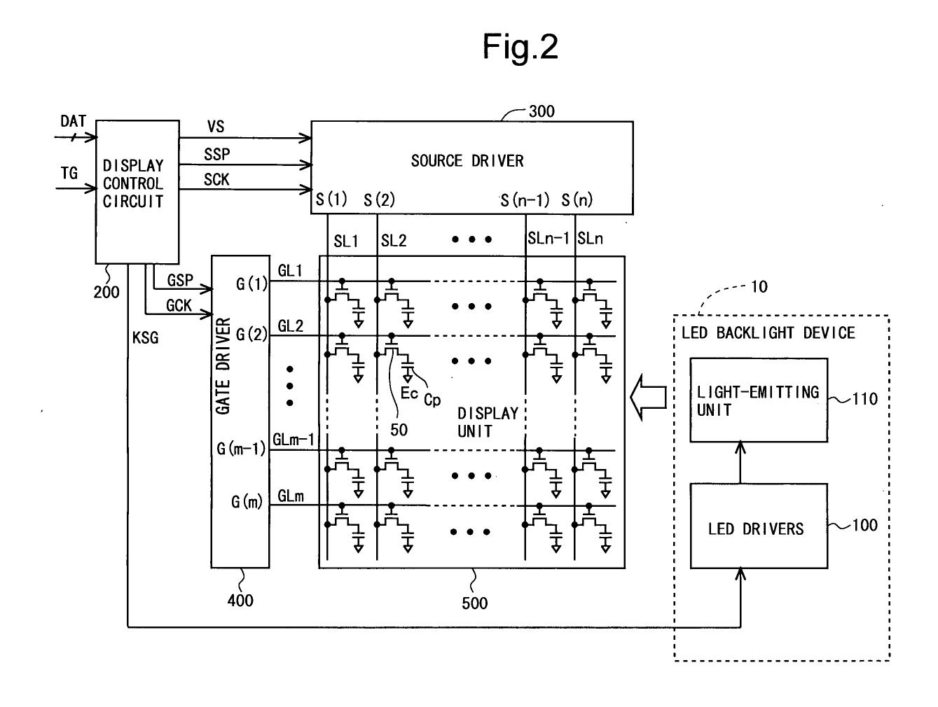

FIG. 2 is a block diagram showing an overall configuration of a liquid crystal display device including an LED backlight device (planar illuminating device) 10 according to a first embodiment of the present invention. The liquid crystal display device includes the LED backlight device 10, a display control circuit 200, a source driver (video signal line drive circuit) 300, a gate driver (scanning signal line drive circuit) 400, and a display unit 500. The LED backlight device 10 includes a light-emitting unit 110 including a plurality of light-emitting diodes which compose a backlight for irradiating light from the back side of the display unit 500 (to the display unit 500); and LED drivers 100 that drive the light-emitting diodes in the light-emitting unit 110. Note that, in the liquid crystal display device, the display unit 500 is divided into a plurality of areas and area active drive is performed where the display unit 500 is driven while the luminances of the light-emitting diodes are controlled based on input images in the respective areas.

The display unit 500 includes a plurality of (n) source bus lines (video signal lines) SL1 to SLn; a plurality of (m) gate bus lines (scanning signal lines) GL1 to GLm; and a plurality of (n×m) pixel formation portions provided to be associated with the respective intersections of the source bus lines SL1 to SLn and the gate bus lines GL1 to GLm. The pixel formation portions are arranged in a matrix form, thereby forming a pixel array. Each pixel formation portion includes a TFT 50 which is a switching element having a gate terminal connected to a gate bus line passing through a corresponding intersection, and having a source terminal connected to a source bus line passing through the intersection; a pixel electrode connected to a drain terminal of the TFT 50; a common electrode Ec which is a counter electrode provided so as to be shared by the plurality of pixel formation portions; and a liquid crystal layer which is provided so as to be shared by the plurality of pixel formation portions and which is sandwiched between the pixel electrode and the common electrode Ec. By a liquid crystal capacitance formed by the pixel electrode and the common electrode Ec, a pixel capacitance Cp is formed. Note that although normally an auxiliary capacitance is provided in parallel with the liquid crystal capacitance so as to ensure that a voltage is held in the pixel capacitance, the auxiliary capacitance is not directly related to the present invention and thus the description and depiction thereof are omitted.

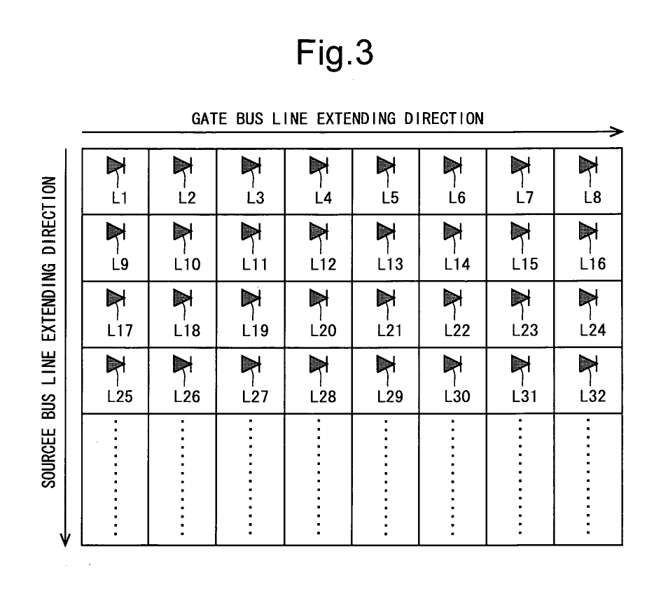

The light-emitting unit 110 is provided on the back side of the display unit 500. The display unit 500 is, as described above, divided into a plurality of areas. As shown in FIG. 3, a plurality of light-emitting diodes are provided in the light-emitting unit 110 such that one light-emitting diode is associated with one area. For example, in the display unit 500 with 1920 source bus lines SL1 to SL1920 and 1080 gate bus lines GL1 to GL1080, 512 areas (32 areas in a gate bus line extending direction and 16 areas in a source bus line extending direction) are provided, and 512 light-emitting diodes are provided in the light-emitting unit 110. The luminances of these light-emitting diodes are controlled based on input images in their associated areas.

The display control circuit 200 receives an image signal DAT and a timing signal group TG including, for example, a horizontal synchronizing signal and a vertical synchronizing signal, which are sent from an external source. Then, the display control circuit 200 outputs a video signal VS; a source start pulse signal SSP, a source clock signal SCK, a gate start pulse signal GSP, and a gate clock signal GCK which are used to control image display on the display unit 500; and a luminance control signal group KSG used to control the luminance of the backlight (the plurality of light-emitting diodes).

The source driver 300 receives the video signal VS, the source start pulse signal SSP, and the source clock signal SCK which are outputted from the display control circuit 200, and applies driving video signals S(1) to S(n) to the respective source bus lines SL1 to SLn. The gate driver 400 repeats application of active scanning signals G(1) to G(m) to the respective gate bus lines GL1 to GLm in cycles of one vertical scanning period, based on the gate start pulse signal GSP and the gate clock signal GCK which are outputted from the display control circuit 200. The LED drivers 100 receive the luminance control signal group KSG outputted from the display control circuit 200, and drive the light-emitting diodes in the light-emitting unit 110. By this, light is irradiated from the back side of the display unit 500.

In the above-described manner, the driving video signals S(1) to S(n) are applied to the respective source bus lines SL1 to SLn, the scanning signals G(1) to G(m) are applied to the respective gate bus lines GL1 to GLm, and light is irradiated to the display unit 500 from the back side thereof, whereby an image is displayed on the display unit 500.

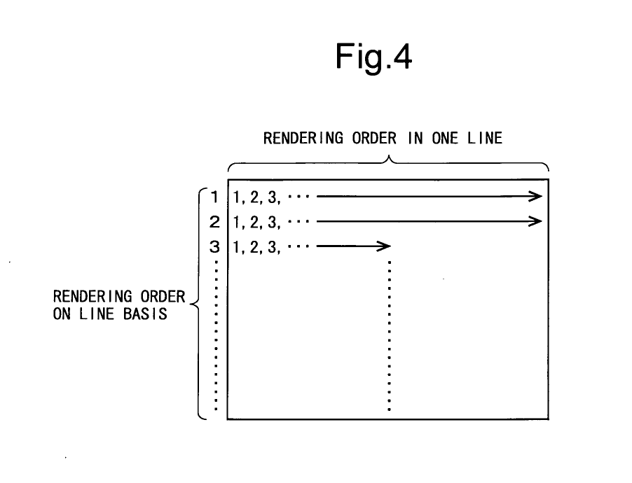

Meanwhile, in the display unit 500 of the liquid crystal display device, rendering is performed in the order shown in FIG. 4. Specifically, taking a look at the rendering order on a line basis, rendering is performed line by line from the top to the bottom of a display screen. Taking a look at the rendering order in one line, rendering is performed pixel by pixel from the left to the right of the display screen.

### 1.2 Configuration of the LED Drivers and Operation of Each Component

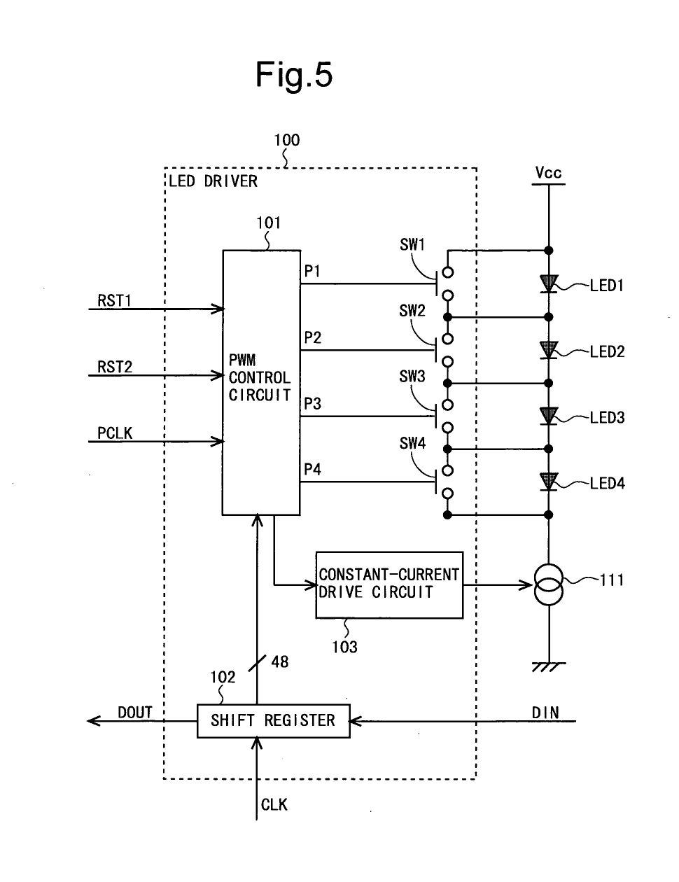

FIG. 5 is a schematic configuration diagram of an LED driver 100 in the present embodiment. Note that an LED driver 100 is provided for each set of light-emitting diodes including a plurality of light-emitting diodes (i.e., one LED driver 100 drives a plurality of light-emitting diodes), and in the following, description is made using an example in which one LED driver 100 is provided per four light-emitting diodes.

As shown in FIG. 5, the LED driver 100 includes bypass switches SW1 to SW4 provided in parallel with respective four light-emitting diodes LED1 to LED4 connected in series in the light-emitting unit 110; a PWM control circuit 101 that controls the on and off states of the bypass switches SW1 to SW4 by PWM signals P1 to P4; a shift register 102 for setting values according to the target luminances of the respective light-emitting diodes LED1 to LED4, in predetermined registers (registers REG1 to REG4 which will be described later); and a constant-current drive circuit 103 for providing a constant current to the set of light-emitting diodes by allowing an FET or the like to function as a constant-current source 111.

To the LED driver 100 are provided, as a luminance control signal group KSG, an input data signal DIN, a clock signal CLK, a PWM control circuit clock signal PCLK, a first reset signal RST1, and a second reset signal RST2 from the display control circuit 200. Note that the role (function) of each signal will be described later.

The shift register 102 has 48 stages and performs (within the shift register 102) a shift operation on the input data DIN sent in a serial format, based on the pulses of the clock signal CLK. By this, 48-bit data is outputted from the shift register 102 and the 48-bit data is provided to the PWM control circuit 101.

The PWM control circuit 101 receives the first reset signal RST1, the second reset signal RST2, the PWM control circuit clock signal PCLK, and the 48-bit data outputted from the shift register 102, and outputs PWM signals P1 to P4. Based on the duty ratios of the PWM signals P1 to P4, the on and off states of the bypass switches SW1 to SW4 are controlled. In addition, the PWM control circuit 101 controls the operation of the constant-current drive circuit 103 such that, when the bypass switches SW1 to SW4 are all placed in an on state (i.e., when the light-emitting diodes LED1 to LED4 are all placed in a turn-off state), the current flowing through the constant-current source 111 is zero.

The constant-current drive circuit 103 provides, as described above, a constant current to the set of light-emitting diodes by allowing an FET or the like to function as the constant-current source 111. Note, however, that when the bypass switches SW1 to SW4 are all placed in an on state, the constant-current drive circuit 103 stops the current flow in the constant-current source 111 based on a control signal from the PWM control circuit 101.

By a configuration such as that described above, the LED driver 100 controls the luminances of the light-emitting diodes LED1 to LED4 by controlling the on and off states of the bypass switches SW1 to SW4 based on a luminance control signal group KSG which is sent from the display control circuit 200 according to the target luminances of the light-emitting diodes LED1 to LED4. Note that although the present embodiment describes, as an example, a configuration in which one light-emitting diode is provided per bypass switch, the present invention can also be applied to a configuration in which a plurality of light-emitting diodes are provided per bypass switch.

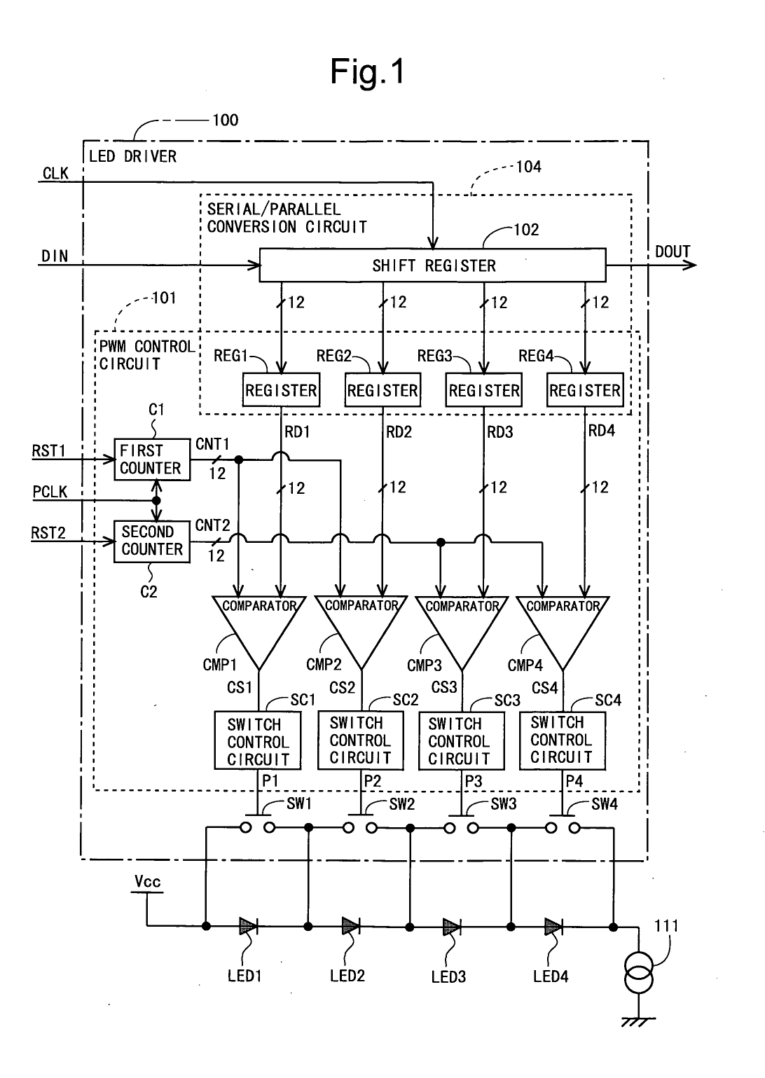

Next, a detailed configuration of the LED driver 100 will be described with reference to FIG. 1. FIG. 1 is a block diagram showing configurations of the PWM control circuit 101 and its peripheral portion included in this LED driver 100. Note that in FIG. 1 the constant-current drive circuit 103 is omitted.

The PWM control circuit 101 includes switch control circuits SC1 to SC4 that control the on and off states of the above-described bypass switches SW1 to SW4; registers REG1 to REG4 provided in one-to-one correspondence with the bypass switches SW1 to SW4; a first counter C1 and a second counter C2 that count clocks; and comparators CMP1 to CMP4 that compare the value of the first counter C1 or the second counter C2 with the values of the registers REG1 to REG4. Note that by the registers REG1 to REG4 and the shift register 102, a serial/parallel conversion circuit is formed.

To the LED driver 100 are provided a clock signal CLK for allowing the shift register 102 to perform a shift operation; an input data signal DIN for storing values according to the target luminances of the light-emitting diodes LED1 to LED4 in the registers REG1 to REG4; a PWM control circuit clock signal PCLK for allowing the first counter C1 and the second counter C2 to count the number of pulses; a first reset signal RST1 for resetting the value of the first counter C1; and a second reset signal RST2 for resetting the value of the second counter C2. Note that the expression “reset the value of the counter” means that the value of the counter is set to zero.

The shift register 102 receives the input data signal DIN in a serial format, and performs a shift operation on the input data signal DIN based on the timing of generation of pulses of the clock signal CLK. Note that the shift operation refers to that data provided to the shift register 102 bit by bit is sequentially transferred stage by stage in 48 stage (48) flip-flop circuits (not shown) included in the shift register 102. From the flip-flop circuits included in the shift register 102, 48-bit data is outputted in parallel, and those data units are stored in the registers REG1 to REG4 12 bits by 12 bits. The data units stored in the registers REG1 to REG4 are respectively provided to the comparators CMP1 to CMP4 as register data values RD1 to RD4.

The first counter C1 and the second counter C2 count the number of pulses of the PWM control circuit clock signal PCLK. Here, the value of the first counter C1 is reset based on a pulse of the first reset signal RST1, and the value of the second counter C2 is reset based on a pulse of the second reset signal RST2. In addition, the values of the first counter C1 and the second counter C2 are incremented by one according to a pulse of the PWM control circuit clock signal PCLK. The value of the first counter C1 is provided to the comparators CMP1 and CMP2 as a first count value CNT1, and the value of the second counter C2 is provided to the comparators CMP3 and CMP4 as a second count value CNT2.

The comparator CMP1 compares the first count value CNT1 with the register data value RD1 and outputs a comparison result signal CS1 indicating whether they match. The comparator CMP2 compares the first count value CNT1 with the register data value RD2 and outputs a comparison result signal CS2 indicating whether they match. The comparator CMP3 compares the second count value CNT2 with the register data value RD3 and outputs a comparison result signal CS3 indicating whether they match. The comparator CMP4 compares the second count value CNT2 with the register data value RD4 and outputs a comparison result signal CS4 indicating whether they match.

The switch control circuits SC1 to SC4 output PWM signals P1 to P4 for controlling the on and off states of their respective corresponding bypass switches SW1 to SW4, based on the comparison result signals CS1 to CS4 outputted from their respective corresponding comparators CMP1 to CMP4. When the bypass switches SW1 to SW4 are placed in an on state by the PWM signals P1 to P4, the corresponding light-emitting diodes LED1 to LED4 are placed in a turn-off state. When the bypass switches SW1 to SW4 are placed in an off state by the PWM signals P1 to P4, the corresponding light-emitting diodes LED1 to LED4 are placed in a turn-on state. Note that, in the following, description is made assuming that when the logic level of the comparison result signal is a high level the switch control circuit places the bypass switch in an on state, and when the logic level of the comparison result signal is a low level the switch control circuit maintains the state of the bypass switch as it is.

Note that, in the present embodiment, by the PWM control circuit 101, a PWM signal generating unit is implemented; by the registers REG1 to REG4, luminance correspondence value holding units are implemented; and by the comparators CMP1 to CMP4 and the switch control circuits SC1 to SC4, switch switching units are implemented. Note also that by the first reset signal RST1 and the second reset signal RST2, timing control signals are implemented.

### 1.3 Control of the Luminances of the Light-Emitting Diodes

Next, specifically how control of the luminances of the light-emitting diodes is performed in the present embodiment will be described. In the present embodiment, the first counter C1 and the second counter C2 are 12 bits, and the registers REG1 to REG4 provided to be associated with the respective bypass switches SW1 to SW4 are also 12 bits. The on and off states of the bypass switches SW1 to SW4 are controlled based on the results of comparisons between the first count value CNT1 or the second count value CNT2 and the register data values RD1 to RD4. Therefore, in the LED driver 100 according to the present embodiment, PWM control is performed with 4096 clocks (of the PWM control circuit clock signal PCLK) being one cycle. Each of the bypass switches SW1 to SW4 is placed in an off state when the value of a corresponding counter is reset, and is placed in an on state when the value of the corresponding counter matches the value of a corresponding register. By this, each of the light-emitting diodes LED1 to LED4 is placed in a turn-on state only for a desired period (a period according to a target luminance) during one cycle (of PWM control).

Taking a particular look at the bypass switch SW1, the operation of the LED driver 100 will be specifically described below using, as an example, the case of controlling the on and off states of the bypass switch SW1 at a duty ratio of 50 percent. The duty ratio is determined in the display control circuit 200 based on a target luminance which is determined according to an input image in an area associated with the light-emitting diode LED1 whose luminance is adjusted by the bypass switch SW1. Note that in the following the contents of 12-bit data are represented in the format “XXXX_XXXX_XXXX” (X is 0 or 1).

First, a value is set in the register REG1 based on an input data signal DIN sent from the display control circuit 200. Here, since the on and off states of the bypass switch SW1 are controlled at a duty ratio of 50 percent, 12-bit data (luminance correspondence value) “1000_{—}0000_{—}0000” is stored in the register REG1. Note that, for example, when the duty ratio is 25 percent, data “0100_{—}0000_{—}0000” is stored in the register REG1, and when the duty ratio is 75 percent, data “1100_{—}0000_{—}0000” is stored in the register REG1. Likewise, each of the registers REG2 to REG4 also stores 12-bit data indicating a duty ratio which is determined based on an input image in an area associated with a corresponding one of the light-emitting diodes LED2 to LED4.

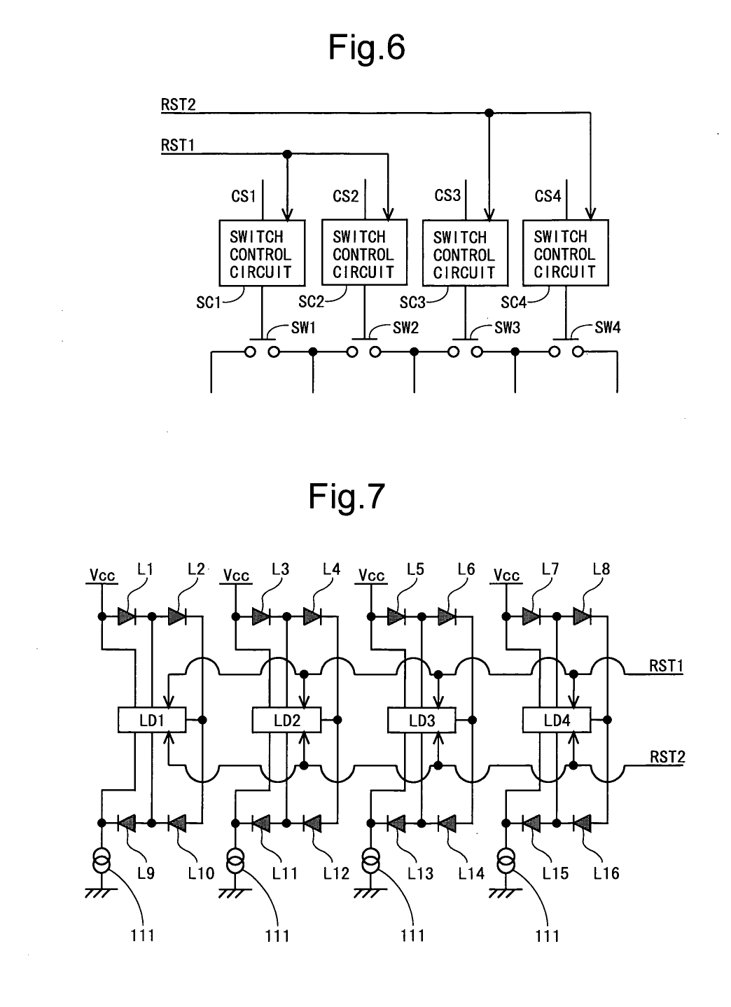

When the first count value CNT1 is reset, the bypass switch SW1 is placed in an off state as an initial state. This may be implemented by a configuration in which, for example, as shown in FIG. 6, a first reset signal RST1 is provided to the switch control circuit SC1, and the switch control circuit SC1 places the bypass switch SW1 in an off state based on a pulse of the first reset signal RST1. By the bypass switch SW1 being placed in an off state in this manner, the light-emitting diode LED1 is placed in a turn-on state. Note that the bypass switch SW2 is placed in an off state as an initial state when the first count value CNT1 is reset. The bypass switches SW3 and SW4 are placed in an off state as an initial state when the second count value CNT2 is reset.

The comparator CMP1 performs a comparison between the first count value CNT1 and the register data value RD1. When the first count value CNT1 matches the register data value RD1, the logic level of a comparison result signal CS1 outputted from the comparator CMP1 is a high level. During a period after the first count value CNT1 is reset and before the first count value CNT1 reaches “1000_{—}0000_{—}0000”, the logic level of the comparison result signal CS1 is maintained at a low level. Note that a comparison result signal CS2 is maintained at a low level during a period from when the first count value CNT1 is reset until the first count value CNT1 matches the register data value RD2. A comparison result signal CS3 is maintained at a low level during a period from when the second count value CNT2 is reset until the second count value CNT2 matches the register data value RD3, and a comparison result signal CS4 is maintained at a low level during a period from when the second count value CNT2 is reset until the second count value CNT2 matches the register data value RD4.

The first count value CNT1 is incremented by one from “0000_{—}0000_{—}0000” according to a pulse of a PWM control circuit clock signal PCLK. By this, when the first count value CNT1 reaches “1000_{—}0000_{—}0000”, the first count value CNT1 matches the register data value RD1, and thus, the logic level of the comparison result signal CS1 changes from a low level to a high level. By this, the switch control circuit SC1 switches the state of the bypass switch SW1 from an off state as an initial state to an on state. As a result, the light-emitting diode LED1 is placed in a turn-off state. Thereafter, until a pulse of the first reset signal RST1 is provided to the LED driver 100 again, the bypass switch SW1 is maintained at the on state and the light-emitting diode LED1 is maintained at the turn-off state. In the above-described manner, the light-emitting diode LED1 is placed in a turn-on state only for a period corresponding to 50 percent of one cycle (of PWM control). Likewise, each of the light-emitting diodes LED 2 to LED4 is placed in a turn-on state only for a period corresponding to its duty ratio during one cycle (of PWM control).

Meanwhile, in the present embodiment, the on and off state control of the bypass switches SW1 and SW2 associated with the light-emitting diodes LED1 and LED2 is performed based on the results of comparisons between the register data values RD1 and RD2 and the first count value CNT1, and the on and off state control of the bypass switches SW3 and SW4 associated with the light-emitting diodes LED3 and LED4 is performed based on the results of comparisons between the register data values RD3 and RD4 and the second count value CNT2. Here, as described above, the first count value CNT1 is reset based on a pulse of the first reset signal RST1, and the second count value CNT2 is reset based on a pulse of the second reset signal RST2. Hence, when the timing of generation of a pulse of the first reset signal RST1 differs from the timing of generation of a pulse of the second reset signal RST2, the timing of turning on of the light-emitting diodes LED1 and LED2 differs from the timing of turning on of the light-emitting diodes LED3 and LED4.

### 1.4 Effects

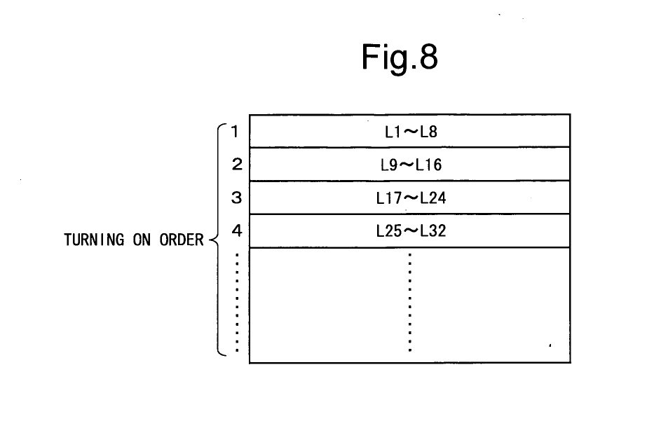

According to the present embodiment, one LED driver 100 is provided per four light-emitting diodes LED1 to LED4, and bypass switches SW1 to SW4 are provided in parallel with the respective light-emitting diodes LED1 to LED4. Here, each of the bypass switches SW1 and SW2 is placed in an off state as an initial state at the timing of generation of a pulse of a first reset signal RST1, and maintains the off state for a period according to the target luminance of a corresponding one of the light-emitting diodes LED1 and LED2. On the other hand, each of the bypass switches SW3 and SW4 is placed in an off state as an initial state at the timing of generation of a pulse of a second reset signal RST2, and maintains the off state for a period according to the target luminance of a corresponding one of the light-emitting diodes LED3 and LED4. Hence, by making the timing of generation of a pulse of the first reset signal RST1 different from the timing of generation of a pulse of the second reset signal RST2, the light-emitting diodes LED1 and LED2 and the light-emitting diodes LED3 and LED4 can be turned on at different timings. Accordingly, as shown in FIG. 7, by employing a configuration in which only two of four light-emitting diodes driven by each LED driver are arranged on the side of the source driver 300 as seen from the LED driver (hereinafter, referred to as the “one side”) and the other two are arranged on the opposite side of the source driver 300 as seen from the LED driver (hereinafter, referred to as the “other side”), and delaying the timing of generation of a pulse of a second reset signal RST2 relative to the timing of generation of a pulse of a first reset signal RST1, those light-emitting diodes arranged on the other side (a second light-emitting diode group) are turned on at a timing delayed relative to the timing of turning on of those light-emitting diodes arranged on the one side (a first light-emitting diode group). In this manner, in the light-emitting unit 110, the light-emitting diodes are turned on in the order shown in FIG. 8. Specifically, the light-emitting diodes are turned on row by row such that “first, light-emitting diodes L1 to L8 are turned on, and then light-emitting diodes L9 to L16 are turned on, and then light-emitting diodes L17 to L24 are turned on, . . . ”. Hence, deterioration of display quality for moving image display which occurs when conventional LED drivers are employed is prevented.

In addition, by arranging each set of light-emitting diodes as shown in FIG. 7, i.e., by arranging a plurality of light-emitting diodes included in each set of light-emitting diodes in two rows on the back side of the display unit 500, all of the light-emitting diodes have a relatively short distance to a corresponding LED driver. Here, since the light-emitting diodes are, as described above, turned on row by row, without causing deterioration of display quality for moving image display, the occurrence of abnormality in turning on which results from a voltage drop between a light-emitting diode and an LED driver is suppressed.

Furthermore, in the present embodiment, when the bypass switches SW1 to SW4 included in the LED driver 100 are all placed in an on state, the current flow in the constant-current source 111 is stopped. Since the distance between light-emitting diodes can be shortened, power consumption is effectively reduced. Here, the reason that the shorter the distance between light-emitting diodes, the more effectively the power consumption is reduced will be described with reference to FIG. 5. To reduce power consumption, it is necessary not to allow a current to flow when LEDs are turned off. For example, when the light-emitting diodes LED1 to LED3 are in a turn-off state and the light-emitting diode LED4 is in a turn-on state, the LED driver 100 consumes power corresponding to the product of a “current of a certain magnitude” and “drop voltages of the light-emitting diodes LED1 to LED4”. At this time, since the light-emitting diodes LED1 to LED3 are in a turn-off state, power that is originally provided for the light-emitting diodes LED1 to LED3 is consumed by the constant-current source 111. Namely, wasted power consumption occurs. In this regard, when the values of the target luminances (luminance data) of the light-emitting diodes LED1 to LED4 are close to one another, the period during which the bypass switches SW1 to SW4 are all placed in an on state increases, and accordingly, the period during which the current flow is stopped increases, suppressing wasted power consumption. Meanwhile, in a display device that performs area active drive, luminance data of light-emitting diodes are determined based on image data. The luminance data of the light-emitting diodes are based on a computation of a plurality of image data. Comparing the contrast between close areas with the contrast between distant areas, normally, the contrast between distant areas is higher. Namely, normally, luminance data have close values between close areas. For the reason described above, the shorter the distance between light-emitting diodes, the longer the period during which the current flow is stopped, whereby power consumption is effectively reduced.

### 2. Second Embodiment

### 2.1 Configuration and Operation

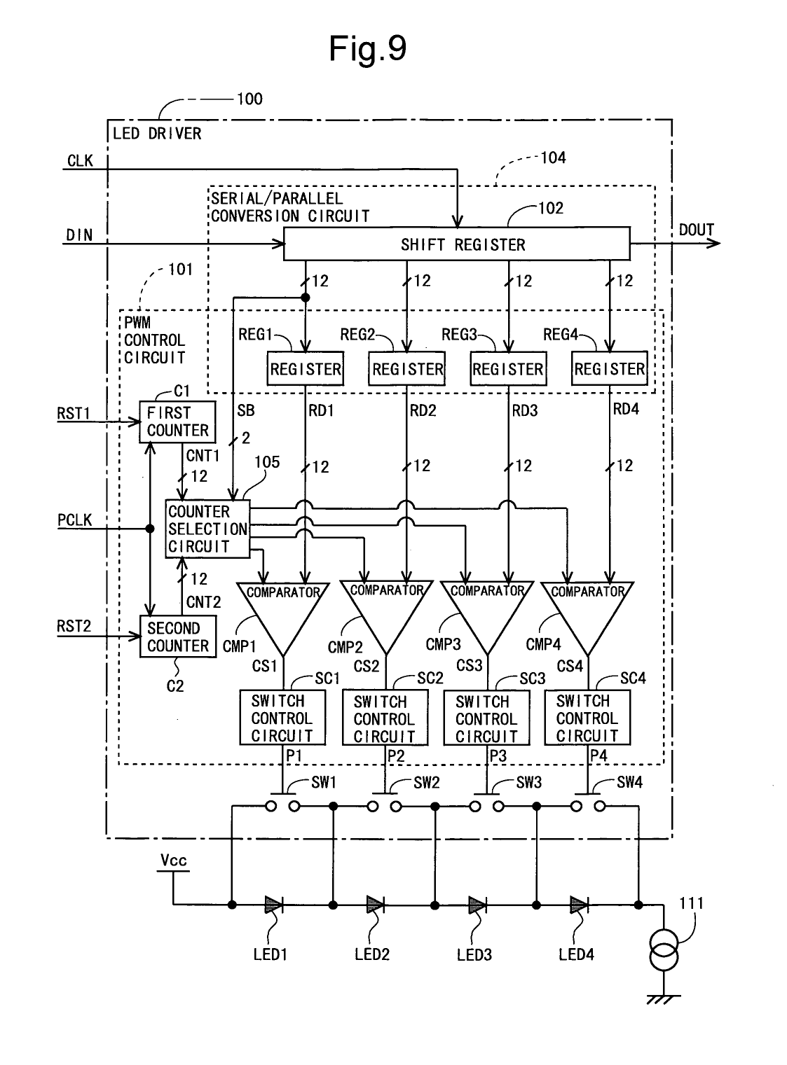

Next, a second embodiment of the present invention will be described. An overall configuration of a liquid crystal display device and a schematic configuration of an LED driver 100 in the present embodiment are the same as those in the first embodiment and thus description thereof is omitted (see FIGS. 2 and 5). FIG. 9 is a block diagram showing configurations of a PWM control circuit 101 and its peripheral portion included in an LED driver 100 in the present embodiment. Differences from the first embodiment will be described below.

In the first embodiment, a first count value CNT1 is provided to comparators CMP1 and CMP2, and a second count value CNT2 is provided to comparators CMP3 and CMP4. On the other hand, in the present embodiment, the configuration is such that a counter selection circuit 105 is provided in the PWM control circuit 101 and a count value (a first count value CNT1 or a second count value CNT2) selected by the counter selection circuit 105 is provided to each of comparators CMP1 to CMP4. The counter selection circuit 105 receives a first count value CNT1, a second count value CNT2, and 2-bit selection data (instruction data) SB which is outputted from a shift register 102 and is for selecting a count value, and provides either the first count value CNT1 or the second count value CNT2 to each of the comparators CMP1 to CMP4. Note that the selection data SB may be set in the counter selection circuit 105 before setting a register data value RD1 in a register REG1, or the shift register may be configured to have 50 bits and data of 2 bits among the 50 bits may be provided to the counter selection circuit 105 as the selection data SB.

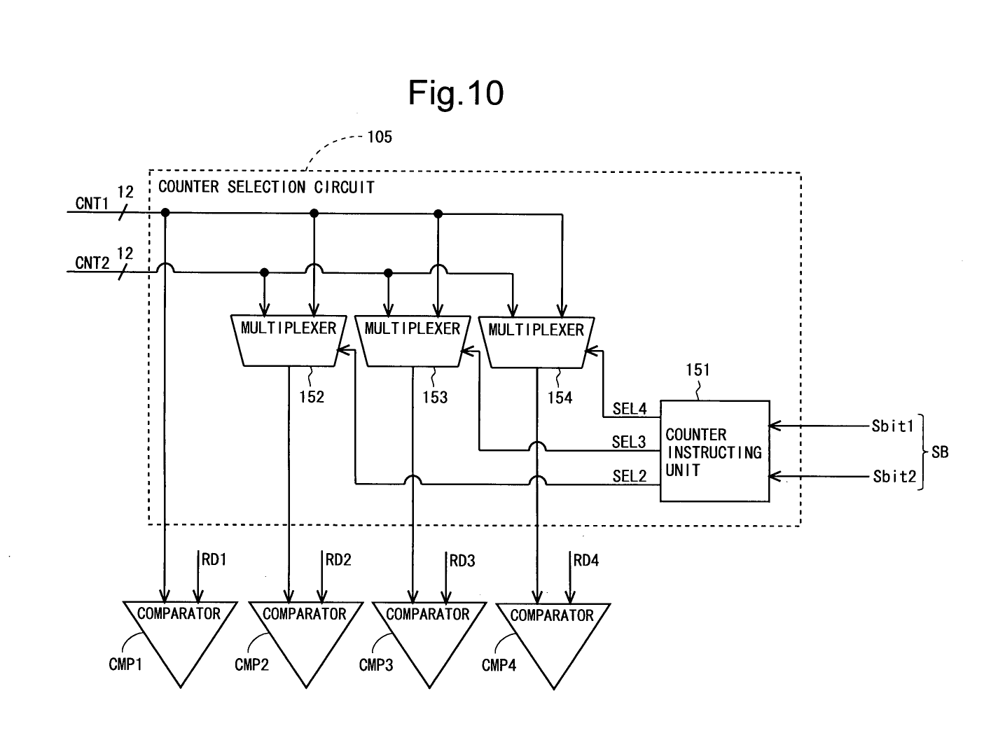

FIG. 10 is a block diagram showing a detailed configuration of the counter selection circuit 105. The counter selection circuit 105 includes a counter instructing unit 151 and three multiplexers 152 to 154. The counter instructing unit 151 receives 2-bit selection data SB (the bits are respectively represented by “Sbit1” and “Sbit2”) and outputs three selection instruction data SEL2 to SEL4. Note that each of the selection instruction data SEL2 to SEL4 is 1-bit data. The multiplexer 152 provides, based on the selection instruction data SEL2, either a first count value CNT1 or a second count value CNT2 to the comparator CMP2. The multiplexer 153 provides, based on the selection instruction data SEL3, either the first count value CNT1 or the second count value CNT2 to the comparator CMP3. The multiplexer 154 provides, based on the selection instruction data SEL4, either the first count value CNT1 or the second count value CNT2 to the comparator CMP4. Note that the first count value CNT1 is provided to the comparator CMP1 regardless of the value of the selection data SB.

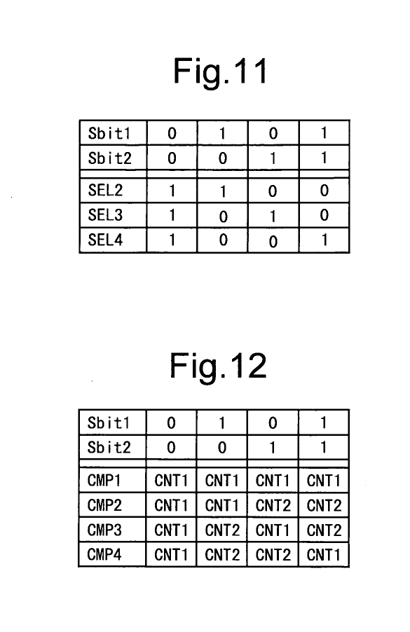

In a configuration such as that described above, the counter instructing unit 151 determines the values of the selection instruction data SEL2 to SEL4 as shown in FIG. 11. For example, when Sbit1 is “1” and Sbit2 is “0”, the selection instruction data SEL2 is “1”, the selection instruction data SEL3 is “0”, and the selection instruction data SEL4 is “0”. When the values of the provided selection instruction data SEL2 to SEL4 are “1”, the multiplexers 152 to 154 provide the first count value CNT1 to the comparators CMP2 to CMP4. When the values of the provided selection instruction data SEL2 to SEL4 are “0”, the multiplexers 152 to 154 provide the second count value CNT2 to the comparators CMP2 to CMP4. As a result, as shown in FIG. 12, a count value (the first count value CNT1 or the second count value CNT2) is provided to each of the comparators CMP1 to CMP4 according to the value of the selection data SB. For example, when Sbit1 is “0” and Sbit2 is “1”, the first count value CNT1 is provided to the comparators CMP1 and CMP3, and the second count value CNT2 is provided to the comparators CMP2 and CMP4.

### 2.2 Effects

According to the present embodiment, a count value (a first count value CNT1 or a second count value CNT2) to be provided to the comparators CMP2 to CMP4 is determined based on selection data SB. Hence, by setting the value of selection data SB taking into account the arrangement of light-emitting diodes LED1 to LED4 (the positional relationship between the light-emitting diodes LED1 to LED4 and an LED driver 100), the light-emitting diodes LED1 to LED4 can be turned on at suitable timings. By this, for example, when the light-emitting diodes LED1 to LED4 are arranged in two rows, by delaying the timing of turning on of those light-emitting diodes arranged in the second row relative to the timing of turning on of those light-emitting diodes arranged in the first row, deterioration of display quality for moving image display is prevented.

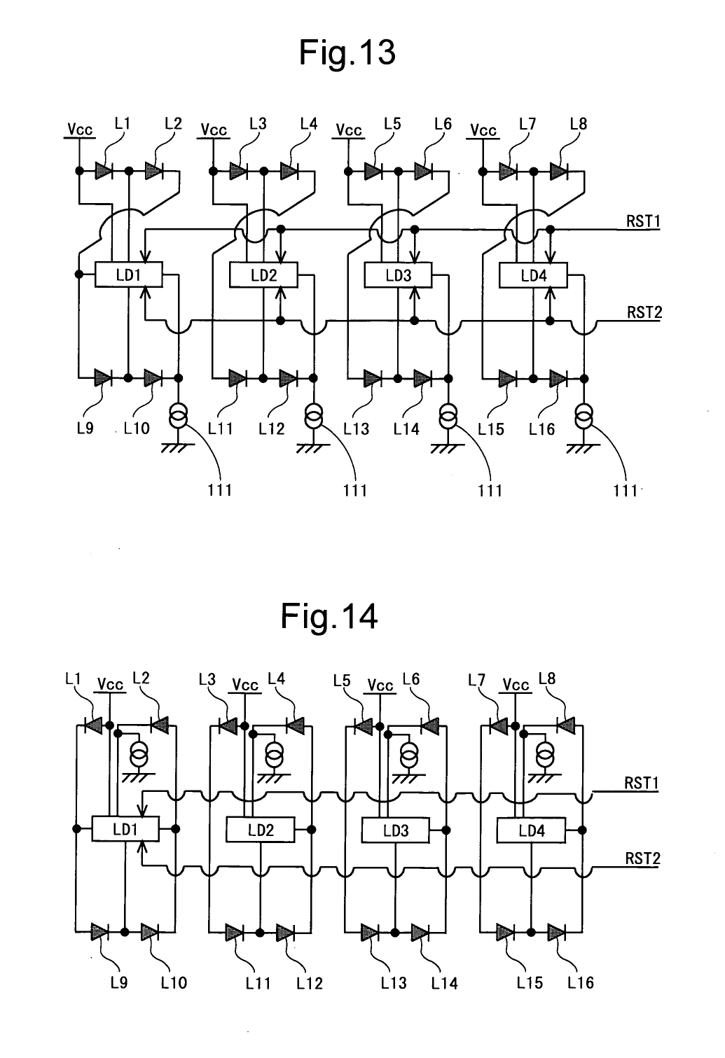

For example, when each set of light-emitting diodes is arranged as shown in FIG. 7, by setting Sbit1 to “1” and Sbit2 to “0” and delaying the timing of generation of a pulse of a second reset signal RST2 relative to the timing of generation of a pulse of a first reset signal RST1, the timing of turning on of those light-emitting diodes arranged on the other side can be delayed relative to the timing of turning on of those light-emitting diodes arranged on the one side. In addition, when each set of light-emitting diodes is arranged as shown in FIG. 13, too, by setting Sbit1 to “1” and Sbit2 to “0” and delaying the timing of generation of a pulse of a second reset signal RST2 relative to the timing of generation of a pulse of a first reset signal RST1, the timing of turning on of those light-emitting diodes arranged on the other side can be delayed relative to the timing of turning on of those light-emitting diodes arranged on the one side.

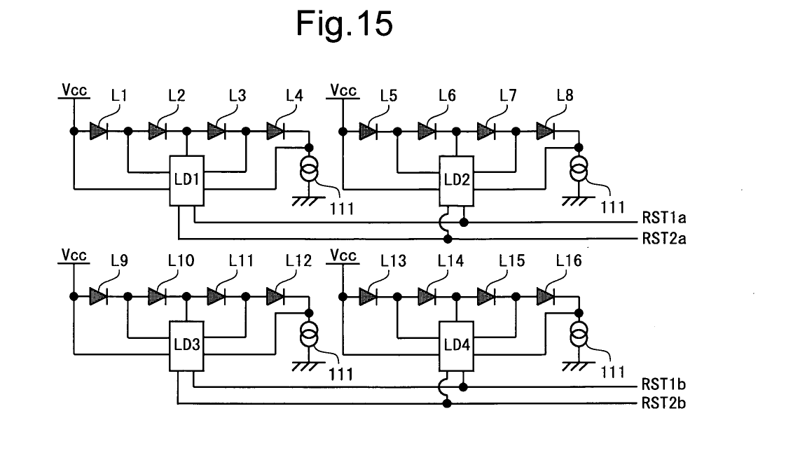

Furthermore, when each set of light-emitting diodes is arranged as shown in FIG. 14, by setting Sbit1 to “1” and Sbit2 to “1” and delaying the timing of generation of a pulse of a second reset signal RST2 relative to the timing of generation of a pulse of a first reset signal RST1, the timing of turning on of those light-emitting diodes arranged on the other side can be delayed relative to the timing of turning on of those light-emitting diodes arranged on the one side. Furthermore, when each set of light-emitting diodes is arranged as shown in FIG. 15, by setting Sbit1 to “0” and Sbit2 to “0”, all light-emitting diodes included in each set of light-emitting diodes can be turned on at the same timing.

As described above, according to the present embodiment, an LED driver is implemented that is capable of suppressing deterioration of display quality for moving image display and the occurrence of abnormality in turning on which results from a voltage drop between a light-emitting diode and the LED driver, while increasing flexibility in the positional relationship between light-emitting diodes and the LED driver.

### 3. Third Embodiment

### 3.1 Configuration and Operation

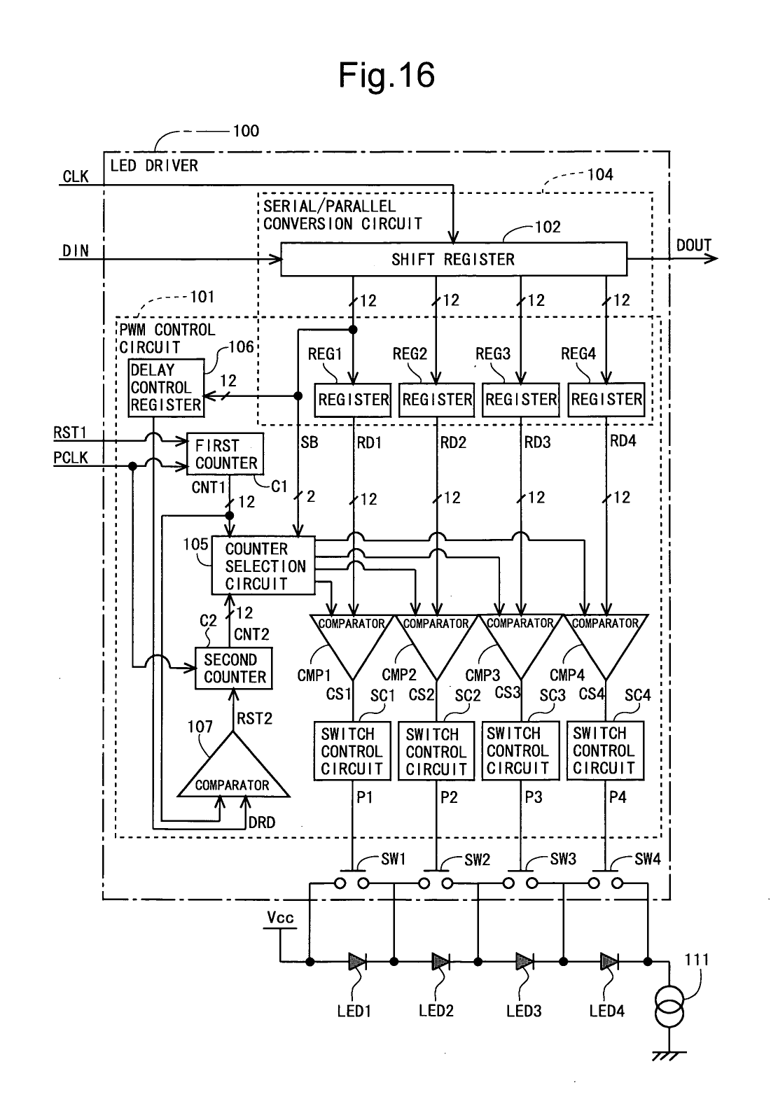

Next, a third embodiment of the present invention will be described. An overall configuration of a liquid crystal display device and a schematic configuration of an LED driver 100 in the present embodiment are the same as those in the first and second embodiments and thus description thereof is omitted (see FIGS. 2 and 5). Note, however, that although in the first and second embodiments two reset signals (a first reset signal RST1 and a second reset signal RST2) are provided to an LED driver 100, in the present embodiment, only the first reset signal RST1 is provided to the LED driver 100 (from an external source of the LED driver 100). FIG. 16 is a block diagram showing configurations of a PWM control circuit 101 and its peripheral portion included in an LED driver 100 in the present embodiment. Differences from the second embodiment will be described below.

In the present embodiment, in addition to the components in the second embodiment, a delay control register 106 and a comparator 107 are provided. The delay control register 106 stores 12-bit data based on a timing at which a second count value CNT2 is to be reset with reference to the reset timing of a first count value CNT1. For example, when the reset timing of the second count value CNT2 is to be delayed relative to the reset timing of the first count value CNT1 by a period corresponding to eight clocks of a PWM control circuit clock signal PCLK, 12-bit data “0000_{—}0000_{—}1000” is stored in the delay control register 106.

The comparator 107 compares the first count value CNT1 with the value of data (hereinafter, referred to as the “delay register value”) DRD stored in the delay control register 106, and outputs a signal indicating whether they match, as a second reset signal RST2 for resetting the second count value CNT2. If the first count value CNT1 matches the delay register value DRD, then the comparator 107 sets the logic level of the second reset signal RST2 to a high level. If the first count value CNT1 does not match the delay register value DRD, then the comparator 107 sets the logic level of the second reset signal RST2 to a low level. Note that a second counter C2 is configured such that, when the logic level of the second reset signal RST2 is a high level, the second count value CNT2 is reset.

Note that, in the present embodiment, by the delay control register 106, a delay control value holding unit is implemented; by the delay register value DRD, a delay control value is implemented; and by the comparator 107, a timing control signal generating unit is implemented.

By a configuration such as that described above, the second count value CNT2 is reset after resetting the first count value CNT1, based on the delay register value DRD which is stored in advance in the delay control register 106. In a counter selection circuit 105, in the same manner as in the second embodiment, a count value (the first count value CNT1 or the second count value CNT2) to be provided to each of comparators CMP1 to CMP4 is determined based on selection data SB. The comparators CMP1 to CMP4 compare their respective corresponding register data values RD1 to RD4 with their respective count values (the first count value CNT1 or the second count value) selected by the counter selection circuit 105, and output comparison result signals CS1 to CS4 indicating whether they match. Then, based on the comparison result signals CS1 to CS4, switch control circuits SC1 to SC4 control the on and off states of their respective corresponding bypass switches SW1 to SW4.

### 3.2 Effects

In the first and second embodiments, two signals, a first reset signal RST1 and a second reset signal RST2, are provided to an LED driver 100 as timing control signals. On the other hand, in the present embodiment, although a first reset signal RST1 is provided to an LED driver 100, a second reset signal RST2 is generated within the LED driver 100. Hence, an LED driver is implemented that is capable of suppressing deterioration of display quality for moving image display and the occurrence of abnormality in turning on which results from a voltage drop between a light-emitting diode and the LED driver, while increasing flexibility in the positional relationship between light-emitting diodes and the LED driver, as in the second embodiment, and while reducing the number of external input signals provided to the LED driver 100.

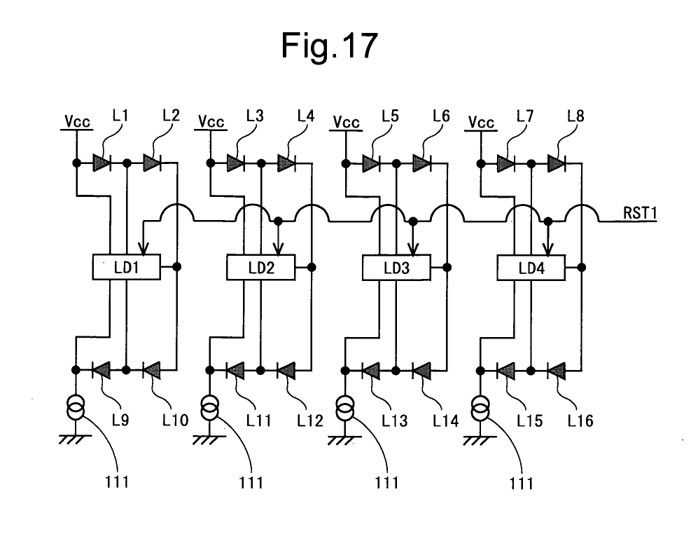

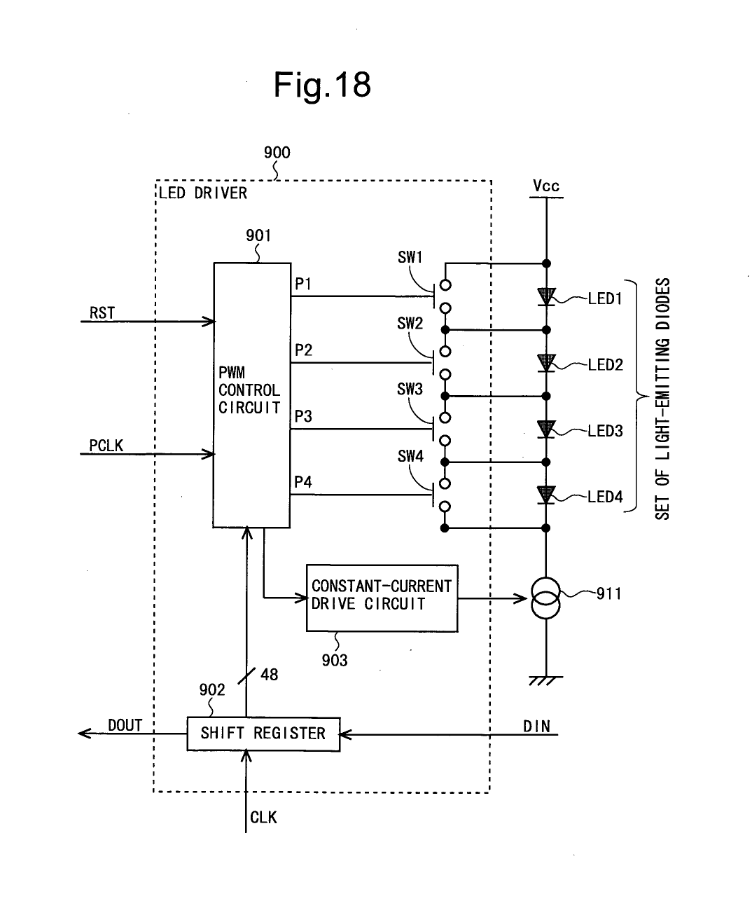

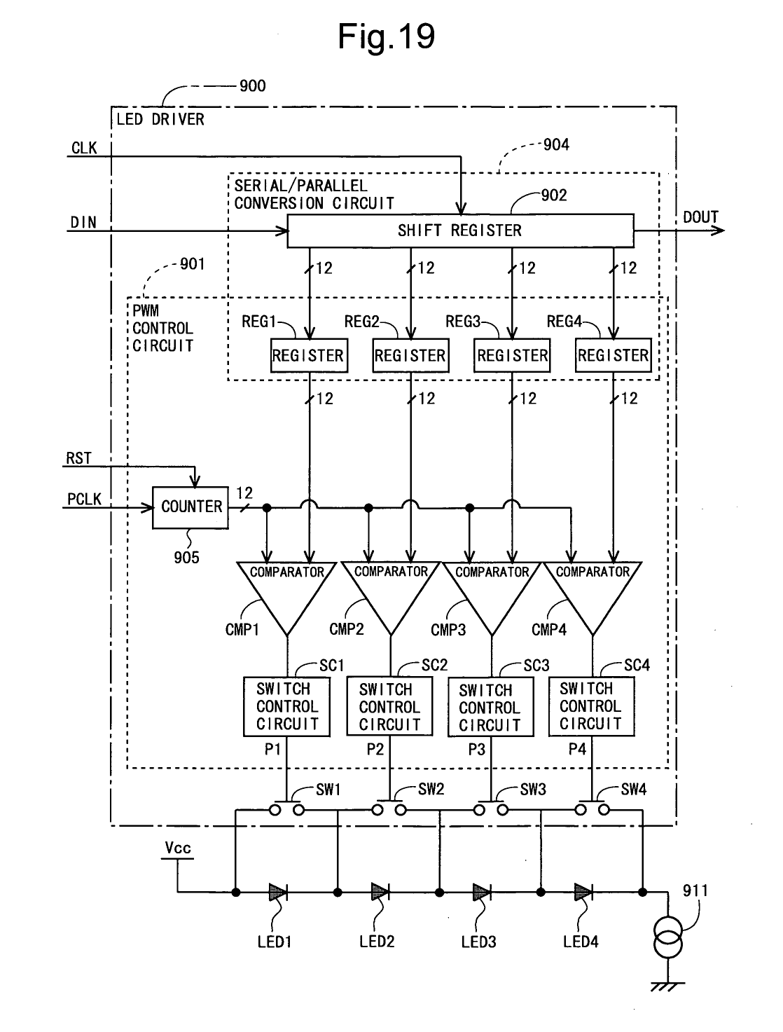

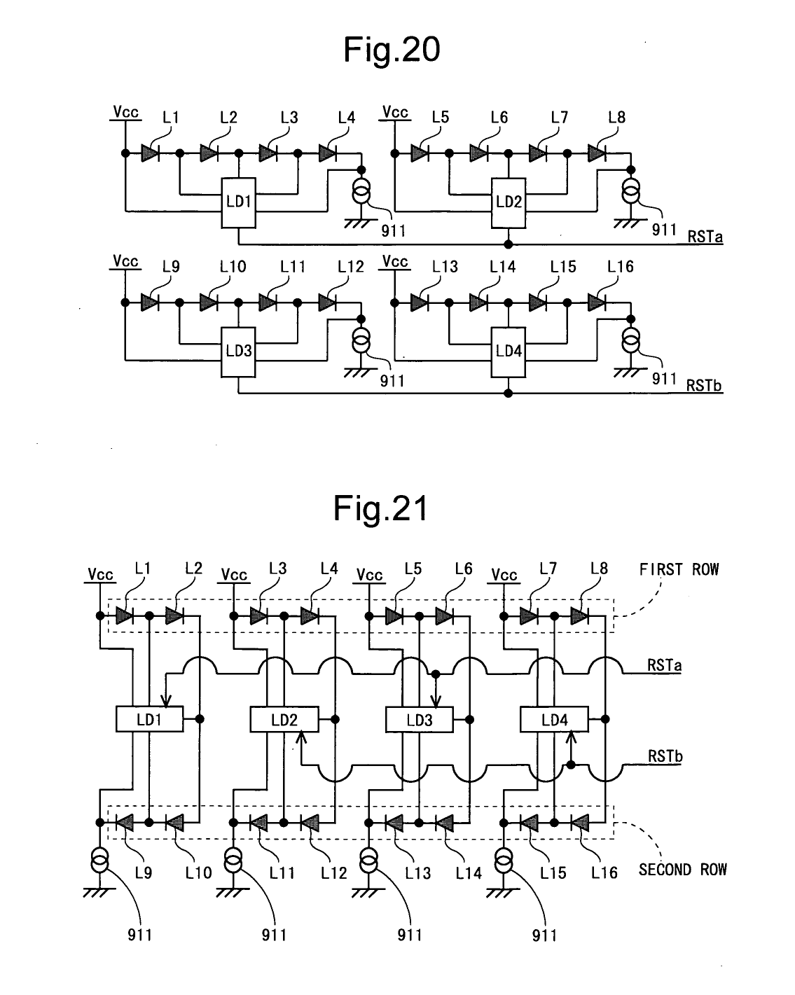

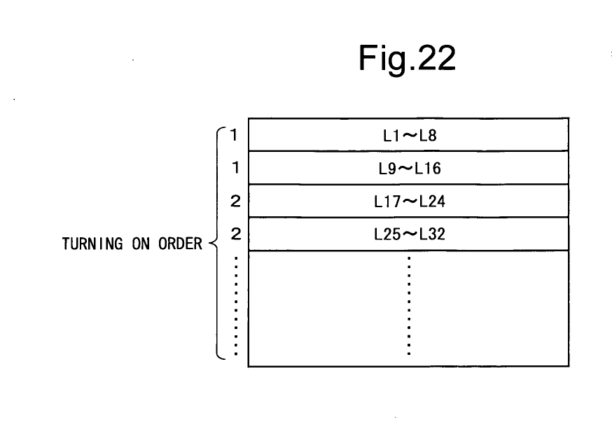

For example, a configuration such as that shown in FIG. 7 in the first embodiment turns to a configuration such as that shown in FIG. 17 in the present embodiment. Namely, in the present embodiment, the number of reset signals provided to each LED driver from an external source is reduced over the first embodiment.

### DESCRIPTION OF REFERENCE NUMERALS

10: LED BACKLIGHT DEVICE

100: LED DRIVER

101: PWM CONTROL CIRCUIT

102: SHIFT REGISTER

103: CONSTANT-CURRENT DRIVE CIRCUIT

104: SERIAL/PARALLEL CONVERSION CIRCUIT

105: COUNTER SELECTION CIRCUIT

110: LIGHT-EMITTING UNIT

111: CONSTANT-CURRENT SOURCE

200: DISPLAY CONTROL CIRCUIT

300: SOURCE DRIVER (VIDEO SIGNAL LINE DRIVE CIRCUIT)

400: GATE DRIVER (SCANNING SIGNAL LINE DRIVE CIRCUIT)

500: DISPLAY UNIT

C1: FIRST COUNTER

C2: SECOND COUNTER

CMP1 to CMP4: COMPARATOR

LED1 to LED4: LIGHT-EMITTING DIODE (LED)

REG1 to REG4: REGISTER

SC1 TO SC4: SWITCH CONTROL CIRCUIT

1. A light-emitting diode driving circuit that drives a plurality of light-emitting diodes which are connected in series with each other and which are connected in series with a constant-current source for allowing a constant current to flow, the light-emitting diode driving circuit comprising:
a plurality of switches, each of which is connected in parallel with each of the plurality of light-emitting diodes or is connected in parallel with a predetermined number of light-emitting diodes; and
a PWM signal generating unit that generates PWM signals for switching on and off states of the respective switches connected in parallel with their corresponding light-emitting diodes, according to target luminances of the respective light-emitting diodes, wherein
the PWM signal generating unit generates the PWM signals based on a plurality of timing control signals for controlling timings at which the plurality of switches are placed in one of an on state and an off state as an initial state.

2. The light-emitting diode driving circuit according to claim 1, wherein the PWM signal generating unit includes:
a plurality of luminance correspondence value holding units that are provided to be associated with the respective plurality of switches and that hold luminance correspondence values, each luminance correspondence value being a value according to a target luminance of a light-emitting diode associated with a corresponding switch and being a value associated with a number of pulses of a clock signal provided from an external source;
a plurality of counters provided such that the plurality of timing control signals are provided thereto, respectively, each counter counting a number of pulses of the clock signal and outputting the number of pulses as a count value; and
a plurality of switch switching units which are provided to be associated with the respective plurality of switches, and each of which compares a luminance correspondence value held in a luminance correspondence value holding unit associated with a corresponding switch with a count value outputted from one of the plurality of counters, and switches on and off states of the switch from its initial state when the luminance correspondence value matches the count value, wherein
each switch is placed in an initial state based on a timing control signal provided to a counter that outputs a count value compared by a switch switching unit associated with the switch, and
a count value outputted from each counter is reset based on a timing control signal provided to the counter.

3. The light-emitting diode driving circuit according to claim 2, wherein a counter that outputs a count value to be compared by each switch switching unit is determined in advance.

4. The light-emitting diode driving circuit according to claim 2, wherein the PWM signal generating unit further includes a counter selecting unit that selects, based on predetermined instruction data, a counter that outputs a count value to be compared by each switch switching unit.

5. The light-emitting diode driving circuit according to claim 2, wherein the plurality of counters include a first counter that receives a timing control signal from an external source; and a second counter other than the first counter, the PWM signal generating unit further includes:
a delay control value holding unit that holds a delay control value, the delay control value being a value according to a difference between timings at which the plurality of switches are placed in an initial state and being a value associated with a number of pulses of the clock signal; and
a timing control signal generating unit that is provided to be associated with the second counter and that generates a timing control signal to be provided to the second counter, based on the delay control value held in the delay control value holding unit and a count value outputted from the first counter, and
the timing control signal generating unit generates the timing control signal such that, when the delay control value held in the delay control value holding unit matches the count value outputted from the first counter, a count value outputted from the second counter is reset.

6. The light-emitting diode driving circuit according to claim 1, further comprising a constant-current drive unit that sets a current flowing through the constant-current source to zero when the plurality of switches are all placed in an on state.

7. A planar illuminating device comprising a light-emitting diode driving circuit according to any one of claims 1 to 6.

8. The planar illuminating device according to claim 7, comprising a plurality of light-emitting diode driving circuits, wherein
a plurality of light-emitting diodes driven by each light-emitting diode driving circuit include a first light-emitting diode group and a second light-emitting diode group, the first light-emitting diode group including light-emitting diodes arranged on one side with reference to an arrangement position of the light-emitting diode driving circuit, and the second light-emitting diode group including light-emitting diodes arranged on an other side with reference to the arrangement position of the light-emitting diode driving circuit, and
a switch connected in parallel with the first light-emitting diode group and a switch connected in parallel with the second light-emitting diode group are placed in an initial state based on different timing control signals.
